(19) United States
(12) Patent Application Publication
(10) Pub. No.: US 2013/0175415 A1
(43) Pub. Date: Jul. 11, 2013

(54) Hair Appliance Valet

(71) Applicant: Elizabeth Mathieu, Tampa, FL (US)

(72) Inventor: Elizabeth Mathieu, Tampa, FL (US)

(21) Appl. No.: 13/365,331

(22) Filed: Feb. 3, 2012

Related U.S. Application Data
(60) Provisional application No. 61/439,738, filed on Feb. 4, 2011.

(51) Int. Cl. F16M 11/00; H01H 3/16; H01R 13/72

(52) U.S. Cl. CPC F16M 11/00; H01R 13/72; H01H 3/16
USPC 248/176.2; 439/501; 200/61.59

(57) ABSTRACT

The Hair Appliance Valet is a mobile six sided container that operates, organizes, holds and stores hair dryers, curling irons, straightening irons and other gadgets used to style hair. There are several sphere shaped cylinders the largest of which specifically operates the hair dryer. The specific cylinder for the hair dryer includes a pressure switch or electronic eye sensor that eliminates the electrical current to the hair dryer when the hair dryer is placed in the cylinder, thereby shutting the hair dryer off automatically. When the hair dryer is picked back up it automatically resumes function. The balance of cylinders holds the hair curling irons, straightening irons and gadgets with corresponding electrical outlets. Below the electrical outlets are multiple apparatuses designed to wrap and hold the appliance cords in place. There is one main retractable power supply cord for the entire unit.

### CROSS REFERENCE TO RELATED APPLICATION

This application claims the benefit of priority of U.S. Provisional Application U.S. 61/439,738 filed Feb. 4, 2011, the entire contents of which are incorporated herein by this reference.

### STATEMENT REGARDING FEDERALLY SPONSORED RESEARCH

Not Applicable

### REFERENCE TO SEQUENCE LISTING

Not Applicable

### BACKGROUND OF THE INVENTION

Containers with electrical systems and devices are well known in the art. They allow the operator to use or store a number of appliances in a manner that avoids hazards while not compromising the function of said appliances.

Traditionally while in full operation one uses several hair appliances at one time inevitably each having their own cords, wands and appendages sprawled over the counter top area. The end of hair appliances by design heat to dangerous levels when the appliance accidently comes in contact with human skin and not the hair, the hair appliances' heated wand or appendage will burn and leave painful, sometimes permanent scares.

Additionally, the operation of drying ones hair becomes awkward when using any hair drying appliance by the design of the hair dryers' on and off function. Generally one lays down the hair dryer appliance in the on position blowing hot air and often times with enough force to propel the hair drying appliance off the counter and onto the floor. Secondly, the hair drying appliance cords tangle with other hair appliances one uses after drying their hair. These types of events occur daily or routinely with every person who uses hair care appliances.

There exists a need in the art for a container specifically designed to both operate and store several hair care appliances. The container ideally is mobile and allows both practical uses while the appliances are in operation, during the heating up or cooling down phase of operation and allows the operator the automatic on to off function of a hair dryer appliance. The need in the art for a container to use a single electrical supply line to multiple outlets for hair care appliances is simple and straightforward. The container by design ideally combines operation, use, organization, safety and storage of multiple hair care appliances.

### BRIEF SUMMARY OF THE INVENTION

The present invention provides a container, adapted for the use on a countertop or the like, designed to hold, organize, store, operate and provide electrical current to hair care appliances. Specifically by design the container has a plurality of sphere shaped cylinders, electrically supplied outlets and apparatus in which the hair care appliance cords wrap around.

The largest of the sphere shaped cylinders is designed with a protruding toggle switch which eliminates the electrical current to the hair dryer appliance when it is placed in the sphere shaped cylinder, thereby automatically shutting it off. When the hair dryer appliance is picked back up, the hair dryer appliance automatically resumes function.

The toggle switch may be substituted by an electronic sensor in a location within the sphere shaped cylinder effectively accomplishing the same on and off automatic function.

The container which is adapted and designed to hold, organize, store, operate and provide electrical current to hair care appliances is completely mobile by design to simply place away in a closet, drawer or cabinet upon completion of use.

The container has one retractable cord in which the electrical current is supplied to the plurality of electric outlets that operate the plurality of hair care appliances.

### BRIEF DESCRIPTION OF THE INVENTION

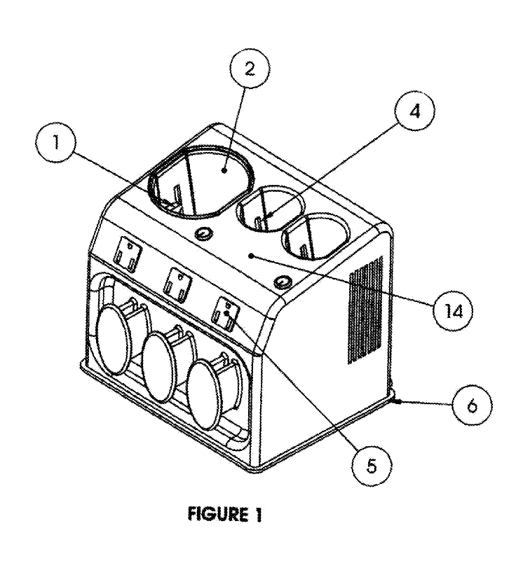

FIG. 1 shows a top-front perspective view of the container for hair care appliances according to an exemplary embodiment of the present invention;

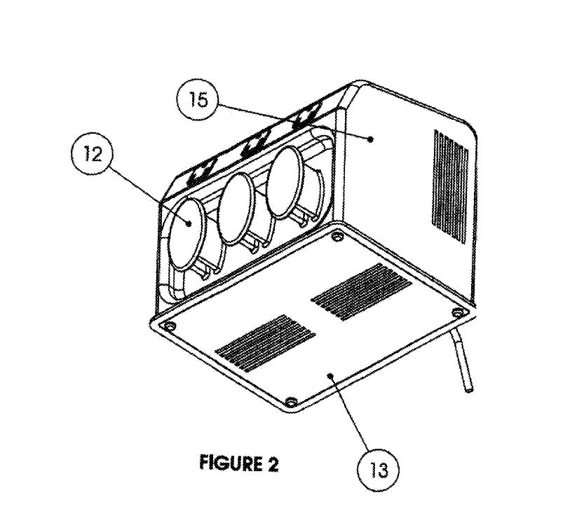

FIG. 2 shows a bottom-front perspective view of the container for hair care appliances according to an exemplary embodiment of the present invention;

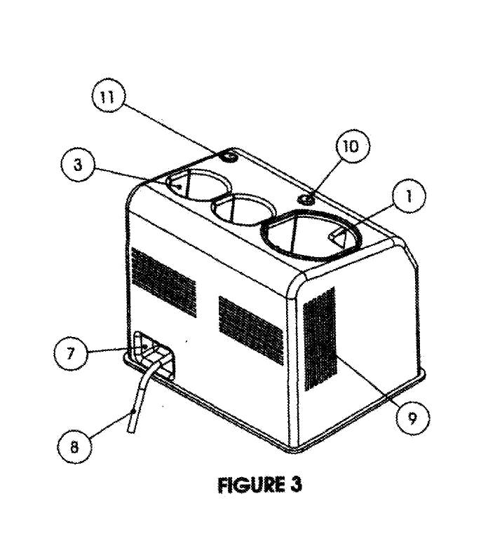

FIG. 3 shows a rear-top perspective view of the container for hair care appliances according to an exemplary embodiment of the present invention;

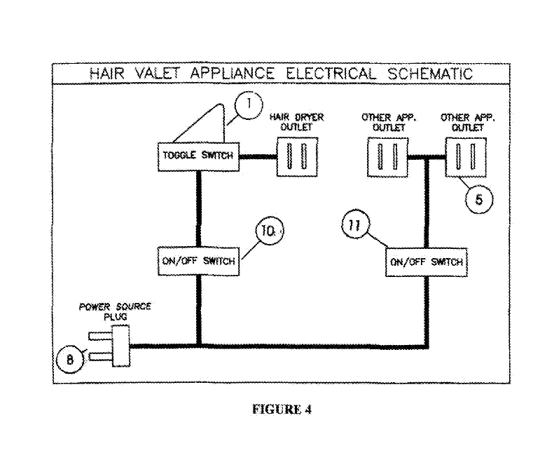

FIG. 4 shows an electrical schematic diagram of the container for hair care appliances according to an exemplary embodiment of the present invention.

### DESCRIPTION OF ITEMS IN FIGS. 1 THROUGH 4

### Item Description

1. Toggle Switch/Electronic Sensor
2. Sphere Shaped Cylinder for Hair Dryer Appliance
3. Sphere Shaped Cylinder for Hair Appliances/Hair Gadget
4. Vertical Ventilation Slats inside Sphere Shaped Cylinder
5. Electric Supply Outlets for operation of Hair Appliances
6. Base Plate/Side of Container
7. Location of Retractable Electric Supply Cord to Operate Container
8. Retractable Electric Supply Cord with attached plug
9. Right side view of multiple Vertical Ventilation Slats
10. Power Supply Button for Toggle Switch Hair Dryer Outlet
11. Power Supply Button for all other Hair Care Appliance Outlets
12. Apparatus recessed with Stem and Oval Disc to wrap Hair Appliance Electric Supply Cord
13. Base Plate of Container with Ventilation Slats and Foot Pads
14. Top Surface of Container
15. Side Surface of Container with Vertical Ventilation Slats
16. Hair Appliance Valet

### DETAILED DESCRIPTION OF THE INVENTION

The description of the preferred embodiment of the present invention herein described in detail for illustrative and structural purposes. It should be noted that variations should be expected and understood that such variations weather by omission, substitution, implementation or application does so without departing from the exemplary embodiment of the present invention.

The terms “a” or “an” do not refer to quantity but denote the presence of at least one of the referenced items. The term “the” when used is not in correlation or part of the title of the present invention.

Referring to the drawings, FIGS. 1 to 4, Items 1 through 16 is a detailed description is of the best currently contemplated modes of carry out exemplary embodiments of the invention. The description is not to be taken in a limiting sense, but is made merely for the purposes of illustrating the general principles of the invention, since the scope of the invention is best defined b the appended claims.

Broadly, an exemplary embodiment of the present invention a container, adapted for use on a countertop or the like, designed to hold, organize, store and provide electric current to hair appliances with a specific hands-free on/off function for certain appliances, such as a hair dryer. The container, also referred to as a Hair Appliance Valet 16, may have a plurality of sphere shaped cylinders 2 and 3. In some embodiments, the Hair Appliance Valet 16 may have three sphere shaped cylinders 2 and 3. The largest of the sphere shaped cylinder 2 may be designed for us with a hair dryer appliance. The sphere shaped cylinder 2 for the hair dryer includes a hidden toggle switch 1, which eliminates the electrical current to the hair dryer when it is placed in the sphere shaped cylinder 2, thereby automatically shutting the hair dryer appliance off. When the hair dryer appliance is picked back up, the hair dryer appliance automatically resumes function. The remaining sphere shaped cylinders 3, may use other hair care appliances, such as curling irons, straightening irons, or other hair care appliances. Located below each sphere shaped cylinder 2 and 3, is an electrical outlet 5 which, when in use, supplies a continuous current, with the exception of the hair dryer electric outlet 5, as described above. Below each sphere shaped cylinders 2 and 3 and the electric supply outlet 5 is a specifically designed apparatus 12 to wrap the extension cord of each appliance being used in that specific sphere shaped cylinder 2 and 3. There may be a separate on/off button 10 for the outlet 5 that supplies the electric current to the largest sphere shaped cylinder 2 designated for the hair dryer appliance which operates the toggle switch 1 located in the largest sphere shaped cylinder 2. There may be a separate on/off button 11 that supplies the electric current to the balance of the electric supply outlets 5 to the matching sphere shaped cylinders 2 and 3 that hold the plurality of hair care appliances. A single electric supply cord 8 may retract from the recessed area 7 in the rear of the hair appliance valet 16 with the appropriate ground fault circuit interrupter (GCFI) attached plug 8. The sphere shaped cylinders 2 and 3 may be designed with heat releasing slats 9 and may be coated with or made from heat resistant materials.

When one uses several hair care appliances at one time, inevitably each having their own cords, wands, appendages and accessories, the cords and parts may get intertwined and are difficult to manage. In addition, other items on the countertop, such as brushes and comes, bows and bobby pins, may be scattered as various appliances are used and moved about. While a person is drying their hair, he or she generally uses a hair brush to set a specific portion of hair to wrap around the brush to dry it. Then, have to locate the dryer pick it up turn it on, hopefully not loosening the portion of hair wrapped around the brush to dry it into place. Dropping the hair is another common occurrence or using the incorrect heat setting as one fumbles to turn the dryer back on. The other option is to leave the hair dryer running in the on position, sitting on the countertop until one can grab the hair dryer again to point it at the specific portion of hair. This blows the items such as brushes, combs, bobby pins, bows or even the blower dryer itself gets propelled off the countertop.

A feature to having all hair care appliances in an organized container, along with the cords neatly wrapped in the cord apparatus 12, and then controlling the on/off function automatically of the hair drying operation using the toggle switch 1 located in the largest sphere shaped cylinder 2 for the hair dryer operation is uniquely attractive to all users. Additionally, the hair care appliances used in the next steps of styling one's hair are heated up and ready to use as they are all nice and neatly resting in the sphere shaped cylinder 2 and 3 and plugged into the electric supply outlet 5 for each hair care appliance with their cords wrapped around the apparatus 12 located below each electric supply outlet 5, all heated up and ready to use. The hair appliance valet 16 of the present invention may further allow for multiple a appliances safely heated up at one time. There is no need to switch out a hair dryer to plug in a curling iron or straightening iron or any other heated hair care appliance and wait for them to heat up.

Referring to FIGS. 1 through 4, a hair appliance valet 16 may include a plurality of sphere shaped cylinders 2 and 3 and two sphere shaped cylinders 3 for storing hair appliances. Typically, three sphere shaped cylinders 2 and 3 may be provided. The sphere shaped cylinders 2 and 3 may be disposed substantially vertically or may be angled relative to the bottom surface 13 of the hair appliance valet 16. For example, the sphere shaped cylinder 2 and 3 may have an axial axis ranging from vertical (90 degrees relative to the bottom surface 6) to, for example, up to about 45 degrees relative to the bottom surface 6. The sphere shaped cylinders 2 and 3 may include slats 4 to allow heat from within the sphere shaped cylinders through the slats 4. The container of the hair appliance valet 16, including the bottom surface 6 and the side surface 15, may also include slats 9 to help ventilate the sphere shaped cylinders 2 and 3. A lip may be formed about the bottom surface 6 to receive the sides 15, front of hair appliance valet 16 and rear of hair appliance valet 16.

In some embodiments, a least one of the sphere shaped cylinders 2 and 3, for example the largest sphere shaped cylinders 2, includes a toggle switch 1 for controlling power to the electric supply outlet 5 corresponding to that particular sphere shaped cylinder 2. The toggle switch 1 may be a protrusion into the sphere shaped cylinders 2 that is spring loaded to protrude into the sphere shaped cylinder 2 and be a closed circuit in that position. When a hair dryer appliance is inserted into the sphere shaped cylinder 2, the protrusion of the toggle switch 1 may be depressed, opening the circuit and interrupting power to the electric supply outlet 5. Therefore, the hair dryer appliance may automatically resume to the on position when removed from the sphere shaped cylinder 2. In some embodiments, each of the sphere shaped cylinders 2 and 3 may include an associated electric supply outlet 1. Located proximate to each electric supply outlet 5 may be an cord apparatus 12, allowing a user to wrap the hair care appliance cords around the apparatus 12 for neat storage while in operation or when the hair appliance valet 16 is place away not in use.

The hair appliance valet 16 may be powered through a single electric power supply cord 8. The electric power supply cord 8 may be retractable and may extent from a recess or cut out area 7 in the back of the container of the hair appliance valet 16. Button switches 10 and 11 may be disposed on the hair appliance valet 16. In some embodiments, one of the button switch 10 for example may control the electric supply outlet 5 associated with the largest of the sphere shaped cylinders 2 (such as the hair dryer appliance sphere shaped cylinder 2). The other button switch 11 may be used to control the remaining outlets 5. In other embodiments, there may be one button switch 11 for each electric supply outlet 5.

The container of the present invention may allow a user to pull a dryer from the sphere shaped cylinders 2 and have the dryer automatically turn on. Then, when the user places the hair dryer appliance back in the sphere shaped cylinder 2, the hair dryer appliance automatically turns off. The sphere shaped cylinders 2 of the hair appliance valet 16 may be appropriately lined to withstand heat or made from heat resistant plastics in order to withstand the heat emitted from plurality of hair care heated appliances. This allows a user to keep their heated curling irons or hair straightening irons, for example, in the sphere shaped cylinder 2 and 3, plugged in and ready to use. The container also organizes the cords of the various hair care appliances, by keeping the cords wrapped on a conveniently recessed area 7, oval shaped disc, and stemmed apparatus 12 and not dangling or strewn across the countertop.

In the manufacturing of the present invention one may use multiple processes and materials. For example when considering plastics as the base material the present invention could be case in two pieces. The top portion would have pre fitted areas for the sphere shaped cylinders with slats the cord wrapping apparatus, buttons, switches and outlets. The electrical components, switches, buttons, cords and outlets would be assembled and placed in the appropriate location. The assembly would be completed by attaching the top unit with the electric components to the base plate for a complete unit. The materials used in the injection molding phase of construction would be able to withstand the heat radiated from the hair care appliances placed in the sphere shaped cylinders.

In a second process using wood or many mould injected plastic parts one would have the six sides of the container, the sphere shaped cylinders and the electric components manufactured and then assembled piece by piece to complete the container.

It should be understood, of course, that the foregoing relates to exemplary embodiments of the invention and that medications may be made with departing from the spirit and scope of the invention as set forth in the following claims.

1. A mobile six sided container that operates hair appliances and gadgets through an electrical current.

2. A mobile six sided container that uses electric components to control the operation of hair appliances and gadgets.

3. A mobile six sided container that organizes hair appliances and gadgets in heat resistance plastic sphere shaped cylinders.

4. The method of claim 1, wherein the six sided container located on the backside a retractable electric supply cord which sends the electric current that operates the electric components.

5. The method of claim 2, wherein the six sided container has one specific sphere shaped cylinder is designed to control the hair dryer with a toggle switch that protrudes into the sphere shaped cylinder and is in the on or open position when the hair dryer is in use. When you place the hair dryer into the sphere shaped cylinder the toggle switch is compressed and automatically turns the hair dryer off. No more fumbling for the on off hair dryer button.

6. The method of claim 2, wherein the six sided container has a unique automatic on and off function allows the operator to control the hair dryer without using the hair dryers built in on off switch.

7. The method of claim 2, wherein the automatic on and off function allows the operator control of the hair dryer which eliminates the placing of the hair dryer while in the on position on the counter top which blows everything around and often the hair dryer falls to the ground or into a sink.

8. The method of claim 2, wherein the sphere shaped cylinder for the hair dryer with the toggle switch can also use an electronic sensor as a substitute for then toggle switch. The automatic function remains intact for the continuous and seamless hair drying motion.

9. The method of claim 2, wherein the pluralities of electric supply outlets are located below each sphere shaped cylinder to operate the specific hair appliance in use.

10. The method of claim 2, wherein the two separate on/off button switches control the electric supply to the outlets. One of the on/off button switches' is dedicated to the hair dryer sphere shaped cylinder outlet. The second and identical on/off button switch is for the remainder of the electric outlets.

11. The method of claim 3, wherein located below each of the electric supply outlet is an apparatus which recesses into the cavity of the container. The apparatus is designed with a small vertical stem by which you wrap the hair appliance cord around thereby organizing each appliance cord and keeping them in place. Attached to the end of the stem is a large oval shaped disc which holds the cord in place once it has been wrapped around the stem several times.

12. The method of claim 3, wherein each of the apparatus for the cords will allow the user to keep the appliance cord organized when the operator unwinds as much or as little cord required in order to use the hair appliance in a more practical manor. The apparatus avoids the inevitable tangling of power supply cords from each of the hair appliances.

13. The method of claim 2, wherein the sides of the container have air ventilation slates. These are place strategically to disperse both the brief air flow from the hair dryer as it enters and exits the sphere shaped cylinder and allows heat to escape while the other hair appliances, curling irons and straightening irons are heating up.

14. The method of claim 1, wherein the backside of the six sided container is a retractable electric supply cord which operates all the electric components of the six sided container.

15. The method of claim 3, wherein the pluralities of sphere shaped cylinders are adapted to receive hair appliances and gadgets that are held in position while not in use.

16. The method of claim 3, wherein the pluralities of sphere shaped cylinders hold hair appliances and gadgets with the heated end of the appliance or gadget in the interior of the pluralities of sphere shaped cylinders thereby organized in a manner to not to grab the hot portion of the appliances and gadgets.

17. The method of claim 2, wherein the pluralities of sphere shaped cylinders and the sides of the six sided container have multiple slates which directs heated air from the hair appliances and gadgets allowing it to be disbursed in a controlled method.

18. The method of claim 3, wherein the overall size of the six sided container with the hair appliances and gadgets organized in the pluralities of sphere shaped cylinders can be picked up and moved to place in cabinet, in a drawer or a closet.
